(19) United States
(12) Patent Application Publication
(10) Pub. No.: US 2007/0003723 A1
(43) Pub. Date: Jan. 4, 2007

(54) Method for continously producing a coated fabric jacket and a coated fabric jacket produced by said method

(75) Inventor: Marc Limpens, Wattrelos (FR)

Correspondence Address: YOUNG & THOMPSON, 745 SOUTH 23RD STREET, 2ND FLOOR, ARLINGTON, VA, 22202, US

(73) Assignee: PENNEL ET SLIPO, ROUBAIX (FR)

(21) Appl. No.: 10/560,235

(22) PCT Filed: Jun. 7, 2004
(86) PCT No.: PCT/FR04/01409

§ 371 Date: Mar. 24, 2006

(30) Foreign Application Priority Data
Jun. 13, 2003 (FR) 03/07162

(51) Int. Cl. B60R 21/16; B32B 37/00

(52) U.S. Cl. 428/36.1; 156/227; 156/289; 156/290

(57) ABSTRACT

A method for continuously producing a coated fabric jacket (1) that includes at least one gasproof tube (2) includes the steps of cutting two strips (15, 25) from at least one coated textile sheet, applying an adhesive material to the surface of the strips, folding the strips, longitudinally fixing each of the folded strips to a first coated textile sheet, placing an anti-sticking agent on the surface of the first sheet between the strips, applying a second sheet to the first sheet, pressing the two sheets to each other and in filling the tube (2) with air in order to expand two strips which form an angle at each joint inside the tube. A coated fabric jacket produced by the method is also described.

The present invention relates to a method for continuously producing a coated fabric jacket and a coated fabric jacket produced using a method of this type.

Coated fabric jackets are used in a number of applications, for example, for forming inflatable tubes having a pneumatic structure, such as life rafts, or for forming beams or inflatable structures, or for producing, for example, floating anti-pollution barrages.

This type of jacket comprises at least one tubular zone and is constituted by two sheets of fabric which are covered with a coating on one or two faces. The coating is constituted by at least one layer of rubber or by at least one layer of plastics material. The jacket is produced by superimposing the two layers of coated fabric and by joining together the two sheets in at least two longitudinal and parallel zones which are separated by at least one non-joined zone in order to produce at least one longitudinal tube.

However, jackets which are produced in this manner have a disadvantage which consists principally in that each of the connection lines between the two sheets, at the inner side of the tube, constitutes a zone of reduced resistance, particularly when the jacket is subjected to shearing stress, with the result that the levels of mechanical performance are not identical over the whole of the tube produced.

In order to produce jackets of this type, another method is also known which consists in producing a woven textile strip which is composed of warp threads and a weft thread and which is covered with a coating on at least one of the faces thereof.

In at least one longitudinal zone, a lower sheet and an upper sheet are formed by passing the weft thread alternately between the warp threads of the lower sheet and alternately between the warp threads of the upper sheet and by passing, at one side and the other of the longitudinal zone, the weft thread alternately between all of the warp threads in order to form connection zones and produce the woven textile strip comprising at least one tubular zone which is bordered by the connection zones.

In this case, however, connection lines at the inner side of the tube(s) constitute discharge zones for the air contained in these tube(s) in such a manner that they progressively deflate.

The object of the invention is to overcome these disadvantages by providing a method for continuously producing a coated fabric jacket comprising at least one tube which is gas-tight, and a coated fabric jacket produced using a method of this type.

The invention therefore relates to a method for continuously producing a coated fabric jacket which comprises at least one gas-tight tube and which is formed from two superimposed sheets of coated fabric formed by warp threads and weft threads, or a coated non-woven fabric, characterised in that

from at least one other sheet of fabric comprising a coating on one face, at least two strips of fabric formed by warp threads and weft threads are cut having a specific width and a length which is substantially equal to the length of the tube to be produced,

an adhesive material is deposited on the face of each of the strips opposite those covered with the coating,

each of the strips is folded in two by folding over two half-faces covered with the adhesive material one onto the other in order to retain those strips in the folded state,

each of the folded strips is longitudinally fixed to the first sheet by positioning the separation line of the half-faces of each of the strips facing each other in order to determine at least one zone for forming a tube,

an anti-adhesive agent is deposited in the zone and on the face of the first sheet contained between the two adjacent strips,

the second sheet is pressed on the first sheet and the two sheets are joined together by adhesively-bonding those sheets in the connection zones which are not covered with the anti-adhesive agent, and

the tube is inflated in order to deploy the two half-faces of each of the strips which forms, at the inner side of the tube in the region of each joint of the two sheets, an angled connection which ensures the mechanical properties and the sealing.

According to other features of the invention:

the fabric of each sheet is covered with the coating on one face,

the fabric of each sheet is covered with the coating on the two faces,

the coating is constituted by at least one layer of rubber or by at least one layer of plastics material,

the fixing of each folded strip to the first sheet is brought about by applying a slight pressure and by heating each folded strip,

the fixing of each folded strip to the first sheet is brought about by adhesively-bonding each folded strip to the first sheet,

the anti-adhesive agent is constituted by a product which is incompatible with the coating of the sheets, such as, for example, an infusible film, a powder or a dispersion, or a solution of anti-adhesive agent,

the adhesion of the two sheets in the zones which are not covered with anti-adhesive agent is brought about by pressing and simultaneously heating the sheets,

the warp threads of the two sheets extend parallel with the longitudinal axis of the corresponding sheet and the weft threads extend perpendicularly relative to the warp threads,

the warp-threads of the two strips extend parallel with the longitudinal axis of the corresponding strip and the weft threads extend perpendicularly relative to the warp threads,

the warp threads of the first sheet are inclined relative to the longitudinal axis of that first sheet and the weft threads of the first sheet extend perpendicularly relative to the warp threads, and after the second sheet is pressed on the first sheet, the warp threads of the second sheet are inclined relative to the longitudinal axis of that second sheet in a direction counter to the direction of inclination of the warp threads of the first sheet, and the weft threads of the second sheet extend perpendicularly relative to the warp threads of that second sheet, and

the warp threads and the weft threads of the two strips are arranged in an identical manner to the warp threads and the weft threads of the first sheet, before the strips are folded.

The invention also relates to a coated fabric jacket, characterised in that it is produced using the method mentioned above.

According to another feature of the invention, the coated fabric jacket comprises n tubular zones and n+1 connection zones.

The features and advantages of the invention will be appreciated from the following description, given by way of example and with reference to the appended drawings, in which:

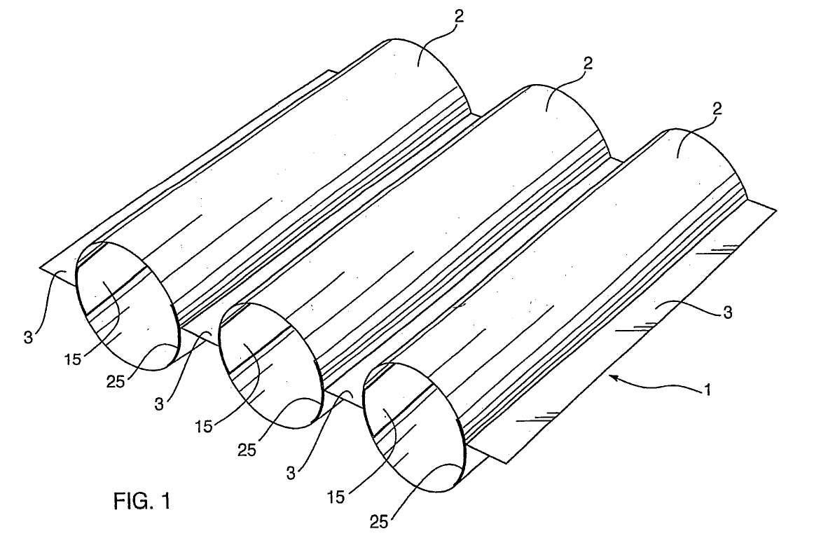

FIG. 1 is a schematic, perspective view of an embodiment of a coated fabric jacket produced using the production method according to the invention,

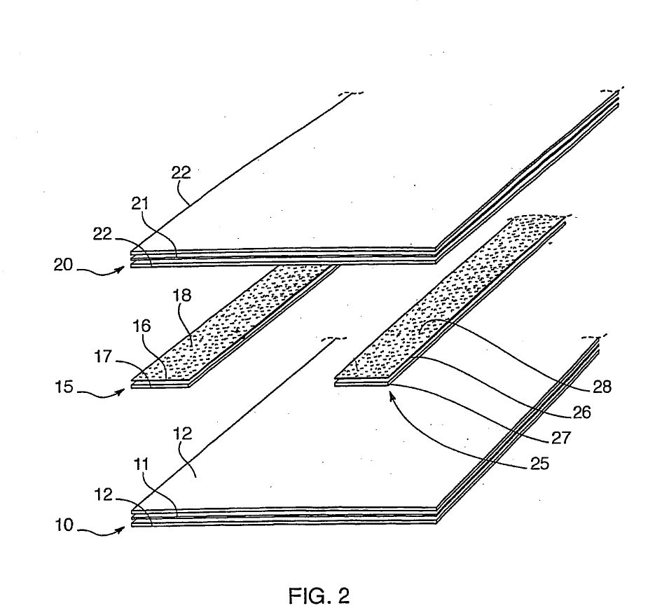

FIG. 2 is a schematic, perspective view of the various elements forming the jacket according to the invention,

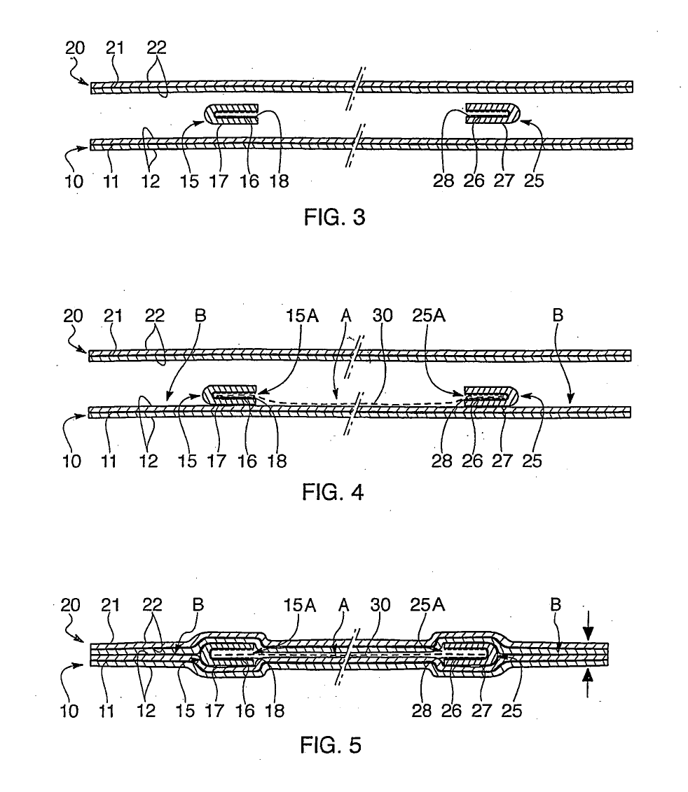

FIGS. 3 to 6 are schematic cross-sections showing the various steps of the method for producing the jacket according to the invention,

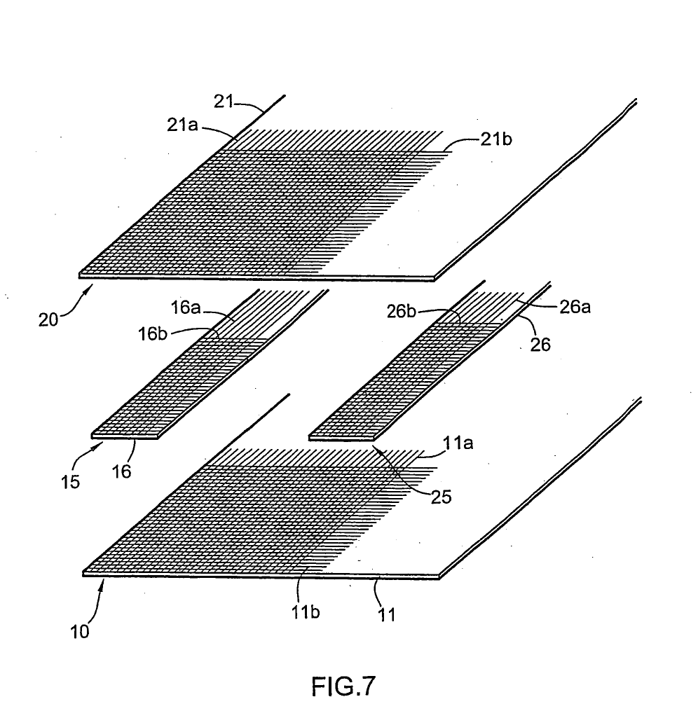

FIG. 7 is a schematic, perspective view showing a first arrangement of the warp threads and the weft threads of the two sheets and the two strips forming the jacket produced using the method according to the invention,

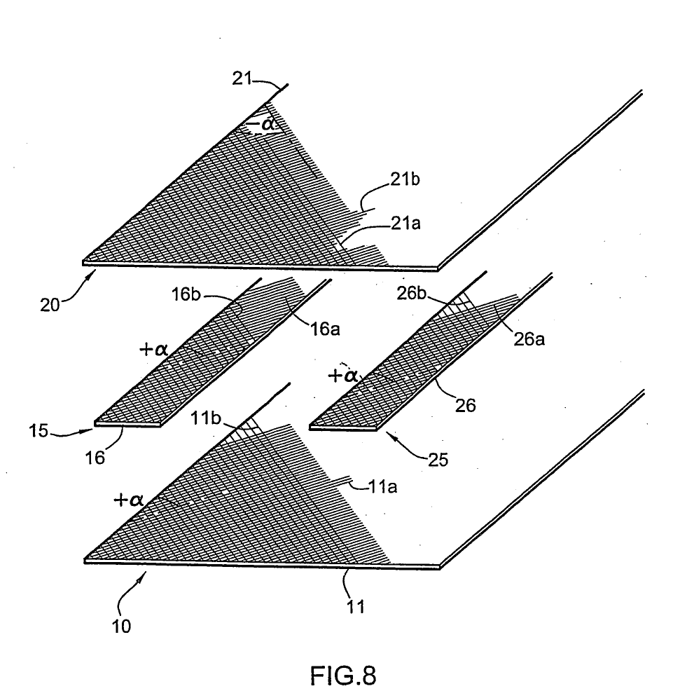

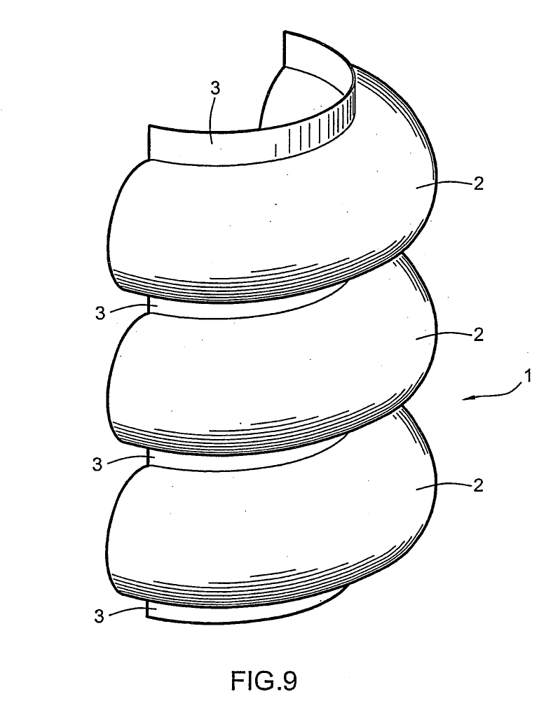

FIG. 8 is a schematic, perspective view showing a second arrangement of the warp threads and the weft threads of the two sheets and the two strips forming the jacket produced using the method according to the invention, and FIG. 9 is a schematic view of a portion of a jacket produced with the arrangement according to FIG. 8.

FIG. 1 is a schematic, perspective illustration of an example of a jacket which is generally designated 1.

According to this embodiment illustrated in FIG. 1, the jacket 1 comprises a plurality of longitudinal zones 2 of tubular form and, at one side and the other of these longitudinal zones 2, a longitudinal connection zone 3 which closes at one side and the other each central tubular zone 2.

With reference now to FIGS. 2 to 6, the various elements forming a jacket 1 will be described and the method for producing this jacket 1 which is composed of a tubular zone 2 and two connection zones 3 which are each arranged at one side and the other of the tubular zone 2, the elements and the method for producing a jacket 1 which is composed of a plurality of parallel tubular zones 2 which are separated from each other by a connection zone 3 being similar.

In FIGS. 2 to 6, the thicknesses of the various elements which form the jacket 1 have deliberately been enlarged in order to facilitate understanding.

The jacket 1 is composed of a first sheet 10 which comprises a woven or non-woven fabric 11 which is produced from polyamide or polyester fibres or from other fibres. The fabric 11 is formed by warp threads 11a and weft threads 11b (FIGS. 7 and 8). This woven fabric 11 is covered on at least one of the faces thereof and, in the embodiment illustrated in the Figures, on each of the faces thereof, with a layer 12 of a coating.

An adhesive is deposited between the fabric 11 and the coating 12 in order to produce a good level of adhesion between these two elements. The deposit of this adhesive is carried out, for example, on a coating machine and the adhesive is formulated to produce a good level of adhesion between the fabric 11 and the coating 12.

The jacket 1 is also composed of a second sheet 20 which comprises a woven or non-woven fabric 21 which is also produced from polyamide or polyester fibres or from other fibres. The woven fabric 21 is formed by warp threads 21a and weft threads 21b (FIGS. 7 and 8). This fabric 21 is covered on at least one of the faces thereof and, in the embodiment, on each of the faces thereof, with a layer 22 of a coating. An adhesive is deposited between the fabric 21 and the coating 22 in order to produce a good level of adhesion between these elements. The deposit of the adhesive is carried out on a coating machine and the adhesive is formulated to produce a good level of adhesion between the fabric 21 and the coating 22.

The coating 12 and 22 deposited on the fabric 11 and 21 is constituted by at least one layer of rubber or at least one layer of plastics material. The deposit of the coating layers 12 and 22 on each fabric 11 and 21 is carried out in conventional manner by means of coating, by means of calendering or by means of extrusion.

The jacket 1 also comprises two strips 15 and 25, respectively, which are cut out from at least one other fabric sheet which is not illustrated.

The strip 15 comprises a fabric 16 which is covered on one of the faces thereof with a coating 17 which is formed by a layer of rubber or a layer of plastics material. The face of the fabric 16 opposite that comprising the coating 17 is covered with an adhesive material 18. In a similar manner, the strip 25 is composed of a fabric 26 which is covered on one of the faces thereof with a coating which is composed of at least one layer of rubber or plastics material. The face of the fabric 26 opposite that comprising the coating 27 is covered with an adhesive material 28.

The fabrics 16 and 26 of the strips 15 and 25, respectively, are also formed by warp threads 16a and 26a, respectively, and weft threads 16b and 26b, respectively, (FIGS. 7 and 8).

Each of the strips 15 and 25 is then folded in order to fold over, one onto the other, the two half-faces covered with the adhesive material 18 and 28, respectively in order to retain those strips 15 and 25 in a folded state, as shown in FIG. 3. The strips 15 and 25 which have been folded in this manner are fixed longitudinally to the first sheet 10 by positioning the separation line 15A and 25A of the half-faces of each of the strips 15 and 25 facing each other in order to determine at least one zone A for forming a tube 2, as shown in FIG. 4. The distance which separates the two folded strips 15 and 25 is a function of the diameter of the tube 2 to be produced.

If the level of adhesion is sufficient between the coating 12 of the sheet 10 and the coating 17 and 27 of the strips 15 and 25, which is in particular the case for a coating which is constituted by a layer of rubber, the folded strips 15 and 25 are fixed to the first sheet 10 by applying a slight pressure and by heating each folded strip.

However, if the level of adhesion is not sufficient, which is the case for coatings which are formed by a layer of plastics material, points of adhesive are deposited between each folded strip 15 and 25 and the first sheet 10.

In the zone A which is located between the separation lines 15a and 25a of the half-faces of each of the strips 15 and 25, the face of the first sheet 10 is covered with an anti-adhesive agent 30. This anti-adhesive agent 30 must be completely incompatible with the coating deposited on the sheets 10 and 20, and it must not melt at the assembly temperatures for the two sheets 10 and 20, as will be seen below. This anti-adhesive agent is constituted by an infusible film, a powder, such as, for example, talcum or bentone, or by a dispersion or a solution of anti-adhesive agent.

The two sheets 10 and 20 are then assembled by pressing the second sheet 20 on the face of the first sheet 10 which is provided with folded strips 15 and 25, as shown by FIG. 5. The two sheets 10 and 20 are joined together by means of adhesion in the connection zones B located at one side and the other of the zone A for forming a tube 2, that is to say, in the zones which are not covered with the anti-adhesive agent 30. This adhesion is brought about by pressing and simultaneously heating the two sheets 10 and 20.

Heating allows, in the case of a coating constituted by rubber, it to be vulcanised and, in the case of a coating constituted by a plastics material, them to be melted. The pressure supplies the cohesion and adhesion between the fabric, the coating of the sheets 10 and 20 and the strips 15 and 25. That operation is carried out continuously on a machine comprising one or more rollers which are heated and provided with jacks in order to bring about the pressure.

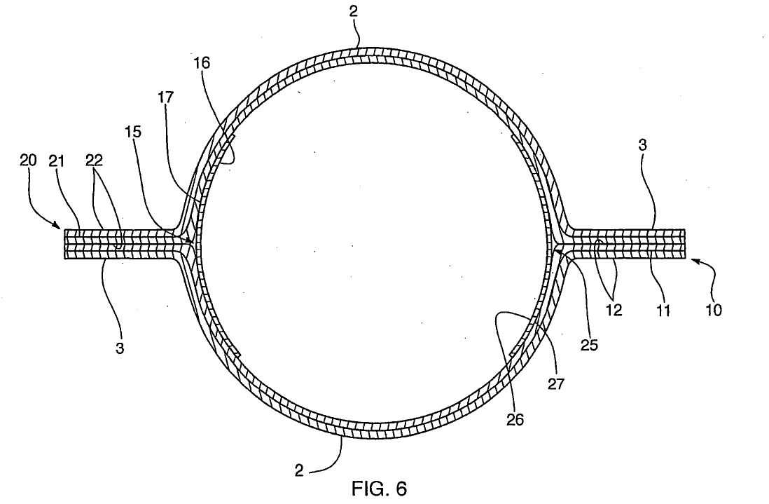

After those assembly operations, a gas is injected into the zone A located between the separation lines 15A and 25A of the folded strips 15 and 25, which has the effect of inflating that zone in order to produce a tube 2. During that inflation, the strips 15 and 25 are deployed and form inside the tube 2, in the region of each joint of the two sheets 10 and 20, an angled connection ensuring the mechanical properties and the sealing, as shown in FIG. 6. Consequently, each joint between the two sheets 10 and 20 is reinforced by a strip constituting an angled connection located inside the tube, which provides assemblies which withstand shearing and, consequently, which have levels of mechanical performance which are identical over the whole of the tube.

In FIGS. 7 and 8, only the fabrics 11, 21, 16 and 26 of the sheets 10 and 20 and the strips 15 and 25 have been illustrated and the spacing between the warp threads and the weft threads of those fabrics has deliberately been enlarged in order to facilitate understanding.

According to a first embodiment illustrated in FIG. 7, the warp threads 11a of the fabric 11 of the sheet 10 extend parallel with the longitudinal axis of that sheet 10 and the weft threads 11b extend perpendicularly relative to the warp threads 11a. Similarly, the warp threads 21a of the fabric 21 of the sheet 20 extend parallel with the longitudinal axis of that sheet 20 and the weft threads 21b extend perpendicularly relative to the warp threads 21a. In a similar manner, the warp threads 16a and 26a of the fabrics 16 and 26 of the strips 15 and 25, respectively, extend parallel with the longitudinal axis of those strips 15 and 25 whilst the weft threads 16b and 26b extend perpendicularly relative to the warp threads 16a and 26a, respectively.

In this embodiment, the fabrics forming the sheets 10 and 20 and strips 15 and 25 are each formed by a fabric referred to as straight thread fabric.

Owing to the arrangement of the warp threads and the weft threads of the fabrics of the sheets 10 and 20 and the strips 15 and 25, the tube(s) 2 forming the jacket 1 is/are, after inflation, rectilinear, as shown in FIG. 1.

According to a second embodiment illustrated in FIG. 8, the warp threads 11a of the fabric 11 of the first sheet 10 are inclined through an angle +α relative to the longitudinal axis of that first sheet 10 and the weft threads 11b of the fabric 11 of the first sheet 1 extend perpendicularly relative to the warp threads 11a.

After the second sheet 21 has been pressed on the first sheet 10, however, the warp threads 21a of the fabric 21 of that second sheet 20 are inclined through an angle −α relative to the longitudinal axis of that second sheet 20, that is to say, in a direction counter to the direction of inclination of the warp threads 11 of the first sheet 10 whilst the weft threads 21b of the second sheet 20 extend perpendicularly relative to the warp threads 21a of the second sheet 20.

The warp threads 16a and 26a and the weft threads 16b and 26b of the fabrics 16 and 26 of the strips 15 and 25 are arranged in an identical manner to the warp threads 11a and the weft threads 11b of the fabric 11 of the first sheet 10. Thus, the warp threads 16a and 26a form an angle +α with the longitudinal axis of the corresponding strip 15 or 25.

After the strips 15 and 25 have been folded, the warp threads 16a and 26a and the weft threads 16b and 26b of the lower half-strip have the same arrangement as the warp threads 11a and the weft threads 11b of the sheet 10 and those warp threads 16a and 26a and those weft threads 16b and 26b of the upper half-strip have the same arrangement as the warp threads 21a and the weft threads 21b of the sheet 20.

Given the orientation of those warp threads and those weft threads, the tube(s) 2 of the jacket 1 has/have, after inflation, the shape of a torus, as shown in FIG. 9.

The diameter of the torus produced in this manner is adjusted in accordance with the value of the angle α. That angle α has a value from greater than 0° to 45°.

In this manner, fabric used for the sheets 10 and 20 and for the strips 15 and 25 is, in this last embodiment, formed by a fabric referred to as bias fabric.

The method according to the invention is used in the production, for example, of inflatable tubes intended for constructing pneumatic structures, such as, for example, life rafts, pneumatic boats, flexible reservoirs or floating anti-pollution barrages, and more generally all devices using inflatable and cylindrical developed shapes.

This method allows the production of a coated fabric jacket comprising n tubular zones forming tubes and n+1 connection zones. A cutting operation carried out continuously in the connection zones allows the tubes to be separated, if necessary.

1. Method for continuously producing a coated fabric jacket (1) which comprises at least one gas-tight tube (2) and which is formed from two superimposed sheets (10; 20) of coated fabric (11; 21) formed by warp threads (11a; 21a) and weft threads (11b; 21b), or a coated non-woven fabric, characterised in that:
from at least one other sheet of fabric comprising a coating on one face, at least two strips (15; 25) of fabric (16; 26) formed by warp threads (16a; 26a) and weft threads (16b; 26b) are cut having a specific width and a length which is substantially equal to the length of the tube (2) to be produced,
an adhesive material (18; 28) is deposited on the face of each of the strips (15; 25) opposite that covered with the coating (17; 27),
each of the strips (15; 25) is folded in two by folding over two half-faces covered with the adhesive material (18; 28) one onto the other in order to retain those strips (15; 25) in the folded state,
each of the folded strips (15; 25) is longitudinally fixed to the first sheet (10) by positioning the separation line (15a; 25a) of the half-faces of each of the strips (15; 25) facing each other in order to determine at least one zone for forming a tube (2),
an anti-adhesive agent (30) is deposited in the zone and on the face of the first sheet (10) contained between the two adjacent strips (15; 25),
the second sheet (20) is pressed on the first sheet (10) and the two sheets (10; 20) are joined together by adhesively-bonding those sheets (10; 20) in the connection zones which are not covered with the anti-adhesive agent (30), and
the tube (2) is inflated in order to deploy the two half-faces of each of the strips (15; 25) which forms, at the inner side of the tube (2) in the region of each joint of the two sheets (10;20), an angled connection which ensures the mechanical properties and the sealing.

2. Method according to claim 1, characterised in that the fabric (11; 21) of each sheet (10; 20) is covered with the coating (12; 22) on one face.

3. Method according to claim 1, characterised in that the fabric (11; 21) of each sheet (10;20) is covered with the coating (12; 22) on the two faces.

4. Method according to claim 1, characterised in that the coating (12; 22, 16; 26) is constituted by at least one layer of rubber.

5. Method according to claim 1, characterised in that the coating (12; 22, 16; 26) is constituted by at least one layer of plastics material.

6. Method according to claim 1, characterised in that the fixing of each folded strip (15; 25) to the first sheet (10) is brought about by applying a slight pressure and by heating each folded strip.

7. Method according to claim 1, characterised in that the fixing of each folded strip (15; 25) to the first sheet (10) is brought about by adhesively-bonding each folded strip to the first sheet.

8. Method according to claim 1, characterised in that the anti-adhesive agent (30) is constituted by a product which is incompatible with the coating (12; 22) of the sheets (10; 20), such as, for example, an infusible film, a powder or a dispersion, or a solution of anti-adhesive agent.

9. Method according to claim 1, characterised in that the adhesion of the two sheets (10; 20) in the zones which are not covered with anti-adhesive agent (30) is brought about by pressing and simultaneously heating the sheets.

10. Method according to claim 1, characterised in that the warp threads (11a; 21a) of the fabrics (11; 21) of the two sheets (10; 20) extend parallel with the longitudinal axis of the corresponding sheet (10; 20) and the weft threads (11b; 21b) extend perpendicularly relative to the warp threads (11a; 21a).

11. Method according to claim 1, characterised in that the warp threads (16a; 26a) of the fabrics (16; 26) of the two strips (15; 25) extend parallel with the longitudinal axis of the corresponding strip (15; 25) and the weft threads (16b; 26b) extend perpendicularly relative to the warp threads (16a; 26a).

12. Method according to claim 1, characterised in that after inflation the tube (2) is rectilinear.

13. Method according to claim 1, characterised in that the warp threads (11a) of the fabric (11) of the first sheet (10) are inclined relative to the longitudinal axis of that first sheet (10) and the weft threads (11b) of the first sheet (10) extend perpendicularly relative to the warp threads (11a), and in that after the second sheet (20) is pressed on the first sheet (10), the warp threads (21a) of the fabric (21) of the second sheet (20) are inclined relative to the longitudinal axis of that second sheet (20) in a direction counter to the direction of inclination of the warp threads (11a) of the first sheet (10), and the weft threads (21b) of the fabric (21) of the second sheet (20) extend perpendicularly relative to the warp threads (21a) of that second sheet (20)

14. Method according to claim 1, characterised in that the warp threads (16a;. 26a) and the weft threads (16b; 26b) of the fabrics (16; 26) of the two strips (15; 25) are arranged in an identical manner to the warp threads (11a) and the weft threads (11b) of the first sheet (10), before the strips (15; 25) are folded.

15. Method according to claim 1, characterised in that after inflation, the tube (2) has the form of a torus.

16. Coated fabric jacket, characterised in that it is produced using the method according to claim 1.

17. Coated fabric jacket according to claim 16, characterised in that it comprises n tubular zones and n+1 connection zones.

18. Method according to claim 2, characterised in that the coating (12; 22, 16; 26) is constituted by at least one layer of rubber.

19. Method according to claim 3, characterised in that the coating (12; 22, 16; 26) is constituted by at least one layer of rubber.

20. Method according to claim 2, characterised in that the coating (12; 22, 16; 26) is constituted by at least one layer of plastics material.
